(19) United States
(12) Patent Application Publication
(10) Pub. No.: US 2026/0023839 A1
(43) Pub. Date: Jan. 22, 2026

(54) VERIFICATION ASSOCIATED WITH A DOMAIN NAME

(71) Applicant: NUM Technology Ltd, Cambridge (GB)

(72) Inventor: Elliott Michael BROWN, Cambridge (GB)

(21) Appl. No.: 19/195,198

(22) Filed: Apr. 30, 2025

Related U.S. Application Data
(63) Continuation of application No. PCT/GB2023/052850, filed on Nov. 1, 2023.

(30) Foreign Application Priority Data
Nov. 2, 2022 (GB) 2216304.2

(51) Int. Cl. G06F 21/44

(52) U.S. Cl. CPC G06F 21/44

(57) ABSTRACT

Methods of or for use in performing verification associated with a first domain name using a hierarchical domain name system are disclosed along with corresponding apparatus and computer-readable media.

A first method comprises: transmitting a domain name system query comprising a second, different domain name, wherein the second domain name comprises the first domain name, wherein the second domain name comprises at least one label preceding the first domain name, wherein the at least one label preceding the first domain name comprises first data, wherein the first data comprises or is based on hashed data, the hashed data having been derived based on input data having been mapped to the hashed data using a hash function, and wherein the input data comprises at least one verifiable identifier; and determining a result of the verification associated with the first domain name based at least in part on a response to the domain name system query.

A second method comprises: creating and/or storing a resource record describing a second, different domain name, wherein the second domain name comprises the first domain name, wherein the second domain name comprises at least one label preceding the first domain name, wherein the at least one label preceding the first domain name comprises first data, wherein the first data comprises or is based on hashed data, the hashed data having been derived based on input data having been mapped to the hashed data using a hash function, and wherein the input data comprises at least one verifiable identifier.

A third method comprises receiving a domain name system query comprising a second, different domain name, wherein the second domain name comprises the first domain name, wherein the second domain name comprises at least one label preceding the first domain name, wherein the at least one label preceding the first domain name comprises first data, wherein the first data comprises or is based on hashed data, the hashed data having been derived based on input data having been mapped to the hashed data using a hash function, and wherein the input data comprises at least one verifiable identifier; and transmitting a response to the domain name system query.

### CROSS-REFERENCE TO RELATED APPLICATIONS

This application is a continuation under 35 U.S.C. § 120 of International Application No. PCT/GB2023/052850, filed Nov. 1, 2023, which claims priority to GB Application No. 2216304.2, filed Nov. 2, 2022, under 35 U.S.C. § 119(a). Each of the above-referenced patent applications is incorporated by reference in its entirety.

### TECHNICAL FIELD

The present disclosure relates to verification associated with a domain name.

### BACKGROUND

A verifying entity (for example, a service provider) may perform verification associated with a domain name by generating a random string, requesting an entity with authority over the domain name to add a Hypertext Markup Language (HTML) comment or meta tag including the random string to a webpage from a website at the domain name, and verifying that the random string has been added by inspecting the webpage. This is described, for example, in International patent application no. PCT/GB2016/054051, the entire contents of which are incorporated herein by reference.

A hierarchical domain name system, such as the Domain Name System (DNS), may also be used to perform verification associated with a domain name. This may involve communication of less data than where webpages are used to perform verification. For example, a verifying entity (such as a service provider) may request a user to verify a domain name before providing services related to the domain name to that user. To verify the domain name, the service provider may generate an authorization code for the domain name and request the user to store the authorization code in a DNS resource record in a zone file for the domain name. In one known example, the authorization code comprises a Globally Unique IDentifier (GUID), such as a 128-bit code generated by combining a local Ethernet serial number with a date and time. In another known example, the authorization code comprises a hash of a combination of (i) a user account ID number, (ii) a domain name being validated, and (ii) a unique secret known only to the verifying entity. Once the user confirms that the authorization code has been stored in the zone file for the domain name, the service provider performs a DNS query for the domain name and checks whether the response to the DNS query includes the expected authorization code. If so, the service provider can determine that the user has authority in relation to the domain name and can perform verification in associated with the domain name accordingly. The reader is referred to US Patent Application Publication Number US 2007/067465 A1 in this regard.

In more detail, domain verification has traditionally worked in the following manner since the mid-2000s. Firstly, in the traditional domain verification process, a domain owner adds their domain name to a service. Examples of such services include, but are not limited to, Google Search Console and Facebook Business Manager. Secondly, the service provider requests the domain owner to verify that they have control over the domain name by adding a DNS record via their DNS provider. The DNS record is usually a TXT or CNAME record. Thirdly, the domain owner logs into their DNS provider and creates the requested DNS record. Fourthly, the service provider queries the newly created DNS record to verify that the domain owner has control over the domain name. If found, the service provider allows the domain owner to add their domain to the service. The process is repeated for each domain name added to each service provider.

However, there are various frictions, dangers, inefficiencies, and limitations of this traditional domain verification process.

Many domain owners are blocked at the second and third steps of this known process. This is because they do not understand the service provider's request and/or do not have direct access to their DNS settings. This friction creates a significant barrier to a service provider onboarding their customers. Domain owners can inadvertently break DNS records when adding verification records. For example, the user may inadvertently take their website and/or e-mail offline. Since this traditional process is repeated for each service provider, it is highly inefficient for users and pollutes DNS zones. Depending on the domain owner's DNS provider and the DNS tools they offer, it may simply be impossible for the domain owner to add the record requested by the service provider. Where a domain owner instructs a third party to act on their behalf, the third party instructs the domain owner to create the TXT record. Examples of such third parties include, but are not limited to, SEO agencies, social media management and marketing agencies. This gives the domain owner little control over the permissions granted to the third party by the service provider.

UK patent application no. GB1906535.8, the entire contents of which are incorporated herein by reference, describes verification associated with a domain name. Verification may be performed by storing hashed data, derived, for example, from contact information, in a TXT resource record at a domain name. A service provider may verify the association with the domain name by obtaining the contact information and domain name, creating a hash of the contact information, obtaining the TXT resource record for the domain name, and comparing the created hash of the contact information to the hashed data in the obtained TXT resource record. If the created hash matches the hashed data, positive verification may be determined.

Further enhancements may, however, be made to the verification described in UK patent application no. GB1906535.8, for example in terms of security and privacy.

### SUMMARY

Various aspects, embodiments, examples and features of the present disclosure are set out in the appended claims.

Further features and advantages will become apparent from the following description, given by way of example only, which is made with reference to the accompanying drawings.

### BRIEF DESCRIPTION OF THE DRAWINGS

FIG. 1 shows a schematic block diagram of an example of a hierarchical domain name system;

FIG. 2 shows a schematic block diagram of an example of a data communications network in accordance with embodiments;

FIG. 3 shows a schematic block diagram of another example of a data communications network in accordance with embodiments;

FIGS. 4A and 4B show a sequence diagram illustrating an example of a method in accordance with embodiments; and

FIG. 5 shows a schematic block diagram of an example of an apparatus in accordance with embodiments.

### DETAILED DESCRIPTION

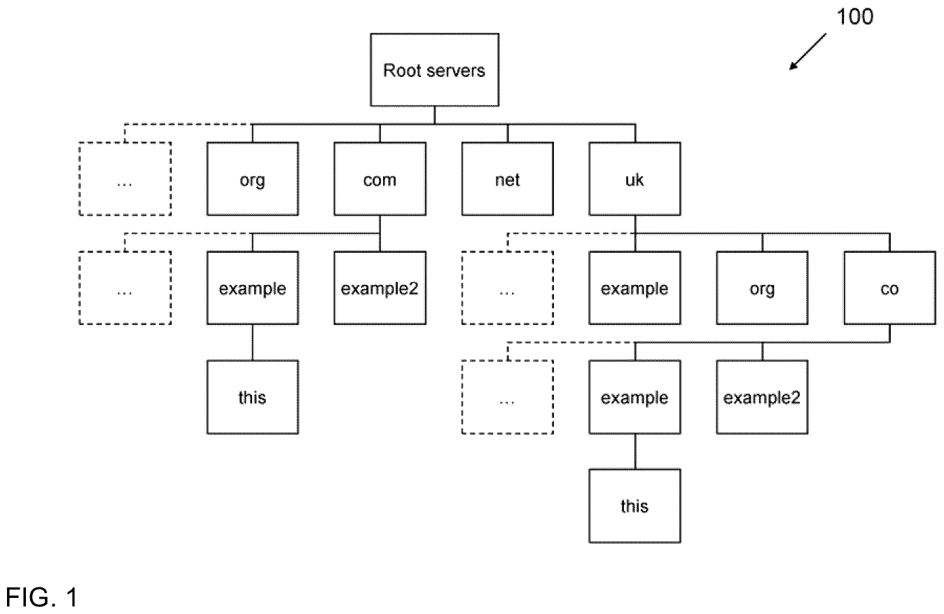

Referring to FIG. 1, there is shown schematically an example of a hierarchical domain name system 100. In this example, the hierarchical domain name system is the DNS.

The DNS is a global, distributed, hierarchical naming system for resources connected to computer networks. DNS is detailed, for example, in IETF RFC 1034 and 1035. One function of the DNS is to translate human-friendly domain names into machine-friendly Internet Protocol (IP) addresses. For example, the DNS may translate a human-friendly domain name of “example.com” into a machine-friendly IP address of 123.45.67.89. The DNS serves as the directory service of the Internet.

Every domain name on the Internet is part of the DNS. The DNS is the cornerstone of the Internet and was created to make the Internet easier to use. The DNS translates easy-to-remember domain names into IP addresses of IP devices, such as servers. The DNS is used every day by billions of people. The DNS is used each time someone enters a domain name into their web browser. The DNS tells a web browser which web server to go to when a website, for example “example.com”, is requested, for example on a computer or smartphone.

Every domain name is hosted on a DNS server. There are many thousands of DNS servers operating worldwide. Information about a domain name is stored in a zone file on a DNS server. A zone file contains DNS resource records. The DNS is made up of name servers that hold information about domain names in DNS zones. Information for each domain name is held in a zone file. Included within the zone file are DNS resource records.

At the highest level of the DNS hierarchy are the root name servers. The root name servers list the authoritative name servers for top-level-domains (TLDs). Examples of TLDs include, but are not limited to, “com” and “uk”.

In the domain name “this.example.com”, the following are all domain names: “this.example.com”, “example.com” and “com”. “com” is a TLD. In addition to being a domain name, “example.com” is a sub-domain of the TLD “com”, and “this.example.com” is a sub-domain of the domain name “example.com”. Each of the parts of a domain name separated by a dot is called a label. In the domain name “this.example.com”, “this”, “example” and “com” are labels.

In the domain name “this.example.co.uk”, the following are all domain names: “this.example.co.uk”, “example.co.uk”, “co.uk” and “uk”. “uk” is a country code TLD (ccTLD). In addition to being a domain name, “co.uk” is a sub-domain of the ccTLD “uk”, “example.co.uk” is a sub-domain of the domain name “co.uk” and “this.example.co.uk” is a sub-domain of the domain name “example.co.uk”. In the domain name “this.example.co.uk”, “this”, “example”, “co” and “uk” are labels.

A TLD (or “name space”) is managed by a Domain Registry (hereinafter “Registry”). For example, VeriSign® is the Registry that manages the “com” name space. Nominet® is the Registry that manages the “uk” name space. Some Registries have split their domain name into sub-domains. For example, Nominet has split their TLD “uk” into “co.uk”, “org.uk”, “me.uk” and others. Nominet allows the creation of domain names at the second level under “uk” in the format of “example.uk”. Creating new domains within a name space is known as a domain name registration.

Although domain names can sometimes be registered directly through Registries, this is discouraged and registration of domain names within the Registry name space is typically through Domain Registrars (hereinafter “Registrars”). A person registering a domain name (e.g. “example.com”) through a Registrar is known as a Registrant. A registrant is allowed to set up further domain names (a sub-domain) within their domain (e.g. this.example.com).

Every domain name has an authoritative name server. An authoritative name server is the name server that holds the current DNS resource records for the domain name. There are various types of DNS resource record. One type of resource record is a Name Server (NS) record. An NS resource record is used to delegate authority for a DNS zone to another name server. The most common DNS resource record is an “A” record. An A record is used to direct website requests to IP addresses. There are other DNS resource record types including, but not limited to, Mail Exchange (MX) records for e-mail, records for free text (TXT) along with other record types.

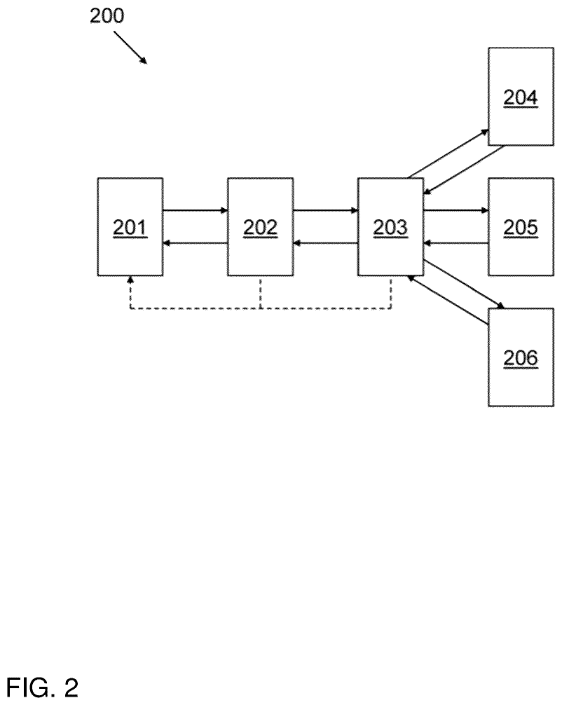

Referring to FIG. 2, there is shown schematically an illustration of an example of a data communications network 200.

The data communications network 200 includes a user device 201. The user device is associated with a user. Examples of user device 201 include, but are not limited to, a smartphone, a tablet computing device, a laptop computer, a desktop computer, a satellite navigation device, an in-vehicle entertainment system and a smart television. The data communications network 200 also includes a local network 202. The local network 202 includes one or more components. An example of a component of the local network 202 is a router. The communications network 200 also includes a DNS resolver 203 at an Internet Service Provider (ISP) of the user. The communications network 200 also includes a root server 204. The communications network 200 also includes a registry name server 205. In this example, the registry name server 205 is an authoritative name server of the top-level domain name “com”. The communications network 200 also includes a registrant name server 206. In this example, the registrant name server 206 is an authoritative name server of the domain name “example.com”.

The process of finding DNS resource records for a domain name is known as DNS resolution or domain name resolution. DNS resolvers are used for this purpose. DNS resolvers determine the authoritative name servers for a given domain name by resolving the full domain name starting with the right-most label and working to the left-most label in the domain name.

In this example, a user enters the domain name “example.com” into a web browser on their user device 201.

If the domain name has been resolved recently, DNS resource records previously retrieved for the domain name will be stored in the user device 201 DNS cache or in the local network 202 DNS cache and will be returned to the user device 201.

If the domain name “example.com” has not been resolved recently, for example if an IP address for the domain name “example.com” is not cached in the local network 202, then the DNS query is passed to the DNS resolver 203.

In this example, the DNS resolver 203 performs recursive DNS lookups, starting with the label “com”. The DNS resolver 203 resolves the domain name starting with the right-most label first and requests the IP address for the authoritative name server 205 for the “com” TLD from the root server 204. The IP address for the authoritative name server 205 for the “com” domain name is returned from the root server 204.

The DNS resolver 203 queries the authoritative name server 205 for the domain name “com” for the IP address of the authoritative name server 206 of the domain name “example.com”.

The authoritative name server 205 for the domain name “com” returns the IP address of the authoritative name server 206 for the domain name “example.com” to the DNS resolver 203. In this example, the authoritative name server 206 for the domain name “example.com” is the name server elected by the Registrant of the domain name “example.com” when they registered their domain name “example.com”.

As the DNS resolver 203 has reached the left-most label of the domain name “example.com”, the DNS resolver 203 requests the DNS resource records for the domain name “example.com” from the authoritative server 206 for the domain name “example.com”. The DNS resolver 203 returns an error if no resource records were found.

Assuming resource records were found for the domain name “example.com”, an IP address of a web server associated with the domain name “example.com” is returned to the DNS resolver 203 in the resource records for the domain name “example.com”. The DNS resolver 203 caches the resource records.

The DNS resolver 203 returns the resource records to the local network 202. The local network 202 caches the resource records.

The local network 202 returns the resource records to the user device 201. The user device 201 caches the resource records. The web browser running on the user device 201 sends a request to the IP address for the web server associated with the domain name “example.com” over Hypertext Transfer Protocol (Secure) (HTTP(S)) for website HTML content for the domain name “example.com”. The IP address for the web server associated with the domain name “example.com” was included in the resource records returned by the DNS resolver 203.

As indicated above, the resource records retrieved for the domain name “example.com” are cached on the user device 201, in the local network 202 and by the DNS resolver 203 for a specified time. The specified time is determined by a Time-to-live (“TTL”) setting of the resource record that was returned.

A DNS query is often sent to a name server using User Datagram Protocol (UDP) on port 53. A DNS query can also travel over Transmission Command Protocol (TCP). DNS over HTTPS (DoH) enables a client to send a DNS query to a resolver over HTTPS. A response to a DNS query from a name server includes an answer to the query. The answer comes from a DNS zone file, which lists the resource records for the domain name. Every domain name is listed in an associated zone file; even TLDs.

The format of a DNS zone file is defined in RFC 1035 (section 5) and RFC 1034 (section 3.6.1). This format was originally used by the Berkeley Internet Name Domain (BIND) software package, but has been widely adopted by other DNS servers. A zone file is a sequence of entries of resource records. Each line in the zone file is a text description that defines a single resource record. The text description comprises several fields separated by white space as follows:

| | | | | |
|---|---|---|---|---|
| NAME | TTL | CLASS | TYPE | DATA |

An example entry in a zone file for the example domain name “example.com” is:

| NAME | TTL | CLASS | TYPE | DATA |
|---|---|---|---|---|
| example.com. | 270 | IN | A | 123.45.67.89 |

The TTL value indicates how long the record should be cached for, which, in this example, is 270 seconds.

An example of a DNS query for any DNS resource record type for the example domain name “example.com” generated using the “dig” command line tool is:

dig example.com ANY

Many nameservers do not respond to DNS queries requesting “ANY” type of resource record. For such nameservers, a resource record type is to be specified.

An example of a response received from a name server for the domain name “example.com” is:

| | | | |
|---|---|---|---|
| example.com. 270 | IN | A | 123.45.67.89 |
| example.com. 194 | IN | MX | 10 mailserver.com |
| example.com. 91816 | IN | NS | ns1.nameserver.com. |
| example.com. 91816 | IN | NS | ns2.nameserver.com. |
| example.com. 1840 | IN | TXT | “v=spf1 ip4 123.45.67.89 -all” |

In this example, the DNS query for the domain name “example.com” has returned five resource records. Each resource record is displayed on its own line. The first resource record, displayed on the first line, is an A record showing the IP address of the server that handles HTTP and HTTPS requests. The second resource record, displayed on the second line, is an MX resource record with a priority of “10” showing that e-mail is handled by “mailserver.com”. The third and fourth resource records, shown on the third and fourth lines, are NS records which show that the authoritative name servers for the domain name are “ns1.nameserver.com” and “ns2.nameserver.com”. The final resource record on the fifth line is a TXT record in a Sender Policy Framework (“SPF”) format.

SPF is an established way to tackle spam. SPF allows domain name owners to list servers that are allowed to send e-mail on behalf of the domain name. The SPF record in the example above means that the only IP address allowed to send e-mail on behalf of the domain name “example.com” is the IP address 123.45.67.89. The final part “-all” means that e-mail from all other IP addresses should be treated as spam. Recipient e-mail servers check the SPF record when receiving e-mail from a domain name and follow the guidance in the SPF to help filter and block spam e-mail.

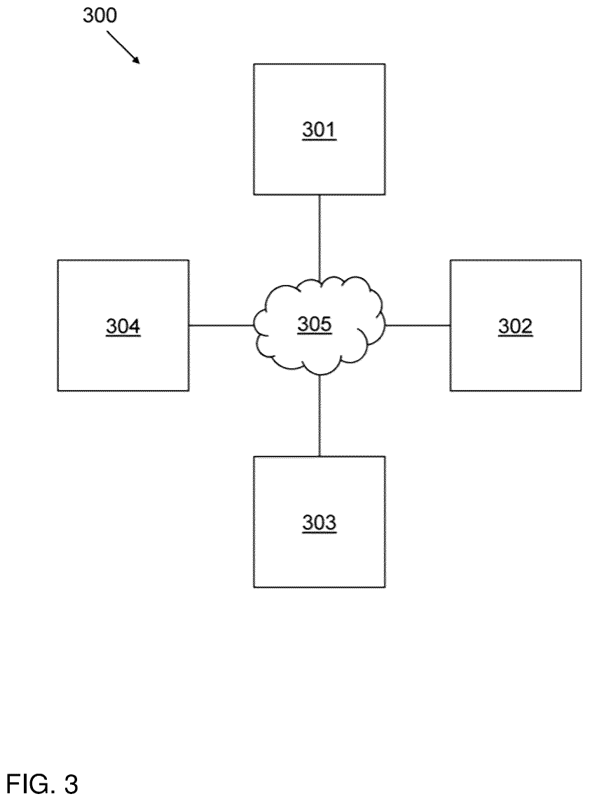

Referring to FIG. 3, there is shown schematically a block diagram of an example of a data communications network 300. The data communications network 300 may be used to process data in the manner described in detail herein. In accordance with some examples described herein, such data processing comprises performing verification associated with a domain name and/or enabling such verification to be performed. Performing verification may result in a positive or negative verification result.

In this example, the data communications network 300 comprises a first apparatus 301, a second apparatus 302, a third apparatus 303 and a fourth apparatus 304. In this example, the four apparatuses 301, 302, 303, 304 are interconnected via a network 305. In this example, the network 305 comprises a computer network. In this example, the computer network 305 is the Internet. In this example, the first apparatus 301 comprises a user device. In this example, the second apparatus 302 comprises a name server. In this example, the third apparatus 303 comprises a first service provider apparatus, which is associated with a first service provider. In this example, the fourth apparatus 304 comprises a second service provider apparatus, which is associated with a second service provider. The techniques described herein may, however, be implemented in a data communications network having a different configuration from that of the example data communications network 300.

Examples described herein enhance verification associated with a domain name using a hierarchical domain name system. In some examples, verification involves determining whether or not an entity has authority in relation to the domain name. The entity may be a user asserting that they have authority in relation to the domain name. Verification may therefore involve determining whether or not the user asserting that they have authority in relation to the domain name does, in fact, have authority in relation to the domain name. This may be determined using one or more verifiable identifiers, such as contact information, provided by the entity and/or other input data. In some examples, verification involves determining whether or not information purported to be associated with the domain name is in fact associated with the domain name. As such, different types of verification associated with a domain name may be performed in accordance with examples described herein.

In some examples, different service providers use the same verification data as each other to perform verification associated with a given domain name. Such verification data may therefore be considered to be “shared” verification data in that the same verification data can be used by multiple different service providers. As such, shared verification data may be considered to be data useable by multiple different verifying entities (for example, service providers) to perform verification associated with the given domain name. Using shared verification data differs from known techniques in which different service providers generate and use different, respective authorization codes. The authorization codes would be different in known techniques where, for example, each service provider generates an authorization code based on a unique secret known only to that service provider. By using shared verification data, the amount of data stored, processed and communicated in the DNS may be reduced, while still enabling verification to be performed. This can enable more scalable verification using the DNS, particularly where relatively large numbers of service providers perform verification associated with a given domain name and/or where the verification data includes a relatively large number of characters. Using shared verification data in accordance with some examples described herein may enable fewer resource records to be used for verification purposes relative to the number of resource records used where different authorization codes are used for different service providers, in particular where there are a relatively large number of service providers and/or where the authorization codes are relatively long.

In some examples, the verification data is derived deterministically. As such, rather than verification data being generated randomly (as may be the case in some known systems), the verification data is derived such that given input data always maps to the same given output data. In contrast to generating a random authorization code for each domain name and storing the randomly generated authorization code in connection with the domain name, in accordance with examples described herein, a service provider (and/or any other verifying entity performing verification) can perform verification in a more ‘on-the-fly’ manner by generating the output data used to perform verification ‘on-demand’ in response to receiving the input data used to derive the output data deterministically. This can reduce the amount of storage used to perform verification compared to a randomly generated authorization code being stored.

In some examples, the verification data, namely data used to verify an association with a domain name, comprises hashed data. Hashed data differs from plaintext data and encrypted data. Plaintext data does not provide any security or privacy in relation to the plaintext data. Encrypting plaintext data to generate encrypted data provides a degree of security and privacy in relation to the plaintext data, but encrypted data is nevertheless intended to be decrypted using a decryption key such that the encryption can, in effect, be reversed and the plaintext data recovered. Hashed data may be generated by using a hash function to map input data to hashed data. In the context of a hash function, the term “input data” as used herein indicates all of the data that is mapped to the hashed data. The input can, in some examples, comprise multiple components. A hash function may map input data of any size onto hashed data of a fixed size. A hash function is effective in accordance with some examples described herein in which the input data to the hash function is not of a fixed size. A hash function is deterministic. As such, a given hash function always maps given input data to the same given hash data. This is effective in accordance with some examples described herein in which given input data is hashed multiple times (for example, by different entities) using the same hash function, and correspondence, or another type of connection, between the resulting hashed data is used to perform verification. In some examples, the hash function is a cryptographic hash function. A cryptographic hash function readily enables verification of whether given input data maps onto given hashed data. However, obtaining input data from given hashed data using a cryptographic hash function is, intentionally, difficult. This can provide security in relation to the input data. This can be particularly, but not exclusively, effective where the input data comprises confidential information, personal information, sensitive information etc. Examples of cryptographic hash functions include, but are not limited to, SHA-1, SHA-2, SHA-3 and MD5. SHA-2 includes, amongst others, the SHA-256 hash function.

In some examples, verification data used for such verification is stored in one or more labels of a given domain name. In some such examples, the given domain name is a sub-domain of the domain name in association with which verification is being performed. In such examples, the given domain name is different from, but includes, the domain name in association with which verification is being performed. Storing the verification data in this manner enables the verification data to be in a separate zone file, if desired, which may reduce the likelihood of undesired modifications being made to the zone file for the domain name in association with which verification is being performed, compared to storing the verification data in the zone file for the domain name in association with which verification is being performed. For example, if the verification data used for performing verification associated with the example domain name “example.com” is stored in a zone file for the domain name “example.com”, there is a risk of other data stored in the zone file for the domain name “example.com” being modified in an undesirable way in the process. Further, by using shared verification data, the verification data can be stored fewer times (for example, only once) than where different authorization codes are used for each service provider. For example, storing (different) authorization codes for four different service providers, for example, may involve four resource record modifications and/or creations, potentially at four separate times, whereas using shared verification data may involve only one resource record modification and/or creation. This may reduce the likelihood of errors in zone files and resource records. Further, where the authoritative name server for the given domain name is different from the authoritative name server for the domain name in association with which verification is being performed, the authoritative name server for the domain name in association with which verification is being performed may be relieved from handling requests relating to verification. For example, the authoritative name server for the example domain name “example.com” can continue to handle conventional requests associated with that domain name, whereas requests associated with verification may be handled by a different name server.

In some examples, and as will be described in more detail below, a user causes a resource record to be created for a sub-domain of a given domain name (for example a sub-domain of “example.com”). The resource record may be created in an existing zone file for the given domain name or may be created in a new zone file for the sub-domain. The sub-domain includes at least one label derived based at least in part on hashing given input data (for example “inputstring”). The sub-domain may include multiple labels derived based at least in part on hashing given input data. The at least one label may be derived solely by hashing the given input data. Alternatively, additional processing, such as base conversion, may be performed. The user supplies the domain name (for example “example.com”) and the input data to a service provider. The service provider performs a hash function (for example, using the SHA-256 algorithm) on the input value and generates hashed data. The service provider runs a DNS query for a sub-domain of the domain name, where the sub-domain includes at least one label derived based at least in part on the hashed data. If the service provider receives a given type of DNS response, this verifies that the input value is associated with the domain name. The given type of DNS response may be a resource record answer. If the service provider receives another type of DNS response, verification that the input value is associated with the domain name may have failed. The other type of DNS response may be an NXDOMAIN (non-existent domain) response or otherwise.

In some examples, the input value comprises a verifiable identifier for the user (for example, an e-mail address, telephone number, etc). In some examples, the input value comprises data that an entity associated with the domain name has shared with the user (for example, bank details, company details, address details, etc). The entity associated with the domain name may be a Registrant of the domain name, an owner of the domain name, etc.

Some examples described herein correspond to proving authority for a domain name. In some examples, an identifier for an entity is hashed and is associated with a DNS zone representing the entity. For example, a DNS TXT resource record may be created for a domain name which comprises at least one label including an identifier (for example, an e-mail address) of an entity (for example, a person) in hashed form. Once created, anyone may be able to check if a particular e-mail address is authorised to act on behalf of that domain.

### Domain Verification Protocol

Examples that will be described in more detail below concern domain verification and a domain verification protocol.

Verification of verifiable identifiers is an important part of online identity. Examples of verifiable identifiers include, but are not limited to, e-mail addresses and telephone numbers. Verification may be as simple as clicking a verification link or receiving an SMS verification code. The example domain verification protocol described herein makes it just as easy to verify a domain.

In more detail, the domain verification protocol aims to automate the domain name verification process. This is the process via which a domain name owner is requested to verify that they have control over a domain name. This is currently a process employed by hundreds of companies like Google, Apple, Amazon, Microsoft, Adobe and Cisco, as well as start-ups.

In accordance with some examples, a domain verification record is a DNS TXT record published to a sub-domain derived from a hashed e-mail address, telephone number, or other verifiable identifier of an authorised party. However, a domain verification record may be another type of resource record (i.e. other than TXT) in other examples. Domain owners and DNS providers create domain verification records. Service providers read domain verification records.

### The Domain Verification Protocol Process

In general terms, and as will be explained in more detail below, the domain verification protocol process may work with the domain verification protocol as follows. Firstly, a domain owner adds their domain name to a service. Examples of such service include, but are not limited to, Google Search Console and Facebook Business Manager. Secondly, the service provider queries the DNS for a domain verification record. If a domain verification record is found, the service provider allows the domain owner to add their domain to the service and the process is complete. If a domain verification record is not found, the service provider instructs the domain owner to create a domain verification record and then verifies the domain verification record at the second step. Every subsequent service provider may use the same domain verification record.

In terms of how the domain verification protocol process works, a domain verification record is a DNS TXT record published to a sub-domain derived from a hashed verifiable identifier that an authorised party can prove control over. As explained above, examples of verifiable identifiers include, but are not limited to, e-mail addresses and telephone numbers. Another example of a verifiable identifier is a blockchain address.

Domain name registrars may automatically create domain verification records for new domain registrations. There are considerable benefits to populating domain verification records for all domains under management.

A User Interface (UI) may be provided for use in performing verification in a hierarchical domain name system. The UI may enable domain owners to configure or create a domain verification record using the UI tool.

The UI may indicate that entered data is only used for building a record.

The UI may prompt the user for a domain name to be verified.

The UI may prompt the user for a verifiable identifier.

The UI may prompt the user to select whether access should be granted to all services or whether restrictions should be set.

The UI may prompt the user to select a privacy setting.

In more detail, the association between the domain and verifiable identifier shown on the UI may be selected to be “Hidden”. Only someone that knows both the domain and verifiable identifier and suspects an association between the two can use a domain verification record to confirm the association.

However, if this association is highly sensitive, the user can select “Secret”. This may be especially effective for a website that is operated anonymously. When “Secret” is selected, only authorised service providers are able to verify the association. As will be explained in more detail below, when the “Secret” option is selected, a salt is added to the verifiable identifier before the result is hashed. Only authorised service providers have access to salts.

The or another UI may enable verification to be performed, for example by a service provider.

The UI may indicate that entered data is only used for checking a record.

The UI may prompt for a domain name to be checked.

The UI may prompt for a verifiable identifier.

The UI may then indicate whether or not the verifiable identifier and the domain name to be checked have been associated with each other in the above-described manner.

Various terms used herein will be explained further below.

The term “Service Provider” is generally used herein to mean an entity that provides one or more services. For example, a service provider may provide products and services attached to domain names. Examples include, but are not limited to, SEO tools (such as Google Search Console), Social Media tools (such as Facebook Business Manager), and Search Engine listings (such as Google Business Profile). Service providers may, alternatively or additionally, provide other types of service. For example, service providers may verify associations between entities. Examples of entities include, but are not limited to, people, companies, properties, assets and so on.

The term “DNS Provider” is generally used herein to mean an entity that provides DNS services. Examples include, but are not limited to, registrars (such as GoDaddy) and standalone DNS services (such as Cloudflare).

The term “User” is generally used herein to mean an entity using a service provided by a service provider.

The term “Domain Owner” is generally used herein to mean an entity with ownership and responsibility over a domain name.

The term “Verifiable Identifier” is generally used herein to mean an identifier that a service provider can verify. The service provider may be able to verify the identifier through automated and/or manual means. For example, a service provider may be able to verify an e-mail address by sending a verification link to that e-mail address. A service provider may be able to verify a phone number by sending an SMS verification code to that phone number.

The term “Domain Verification Record” is generally used herein to mean a DNS TXT record for the domain verification protocol. A domain verification record may be identified as such by starting with the string @dv=N, where N is a version number.

The term “Association Record” is generally used herein to mean a DNS TXT record that associates an authorised party with a domain name.

The term “Salt Reference Record” is generally used herein to mean a DNS TXT record that lists salt store locations and salt IDs, so that salts can be looked up.

### Domain Verification

To expand on an above-identified problem, domain verification is performed by hundreds of service providers. However, it is a complex process for users, involving access to website source files or access to DNS records.

Service providers issue instructions for users to verify domain names. However, these instructions are often beyond the technical capabilities of the layperson. This causes significant onboarding friction, customer support requests and can pose risk to the stability of the website, e-mail or other services operating on the domain name.

A goal of the domain verification protocol is to make it as easy to verify a domain name as it is to verify an e-mail address or telephone number.

The domain verification protocol uses DNS TXT records to create associations between a domain name and an authorised party. Authorised parties are identified using verifiable identifiers. Domain name registrars may automatically create domain verification records upon domain name registration. This clears a simple path for domain registrants to verify domain names automatically.

### Privacy

In terms of privacy, by its nature, the domain verification protocol makes it possible to confirm an association between a verifiable identifier (such as an e-mail address or telephone number) and a domain name. Various steps may be taken to ensure this association is as private as possible.

Firstly, a SHA-256 digest may be used. Verifiable identifiers may only ever be stored as SHA-256 digests. These digests may not be stored in a DNS TXT record using a standardised DNS name. If they were, they could be harvested to facilitate hash breaking attempts. In examples, the digest is used as a DNS label, within the DNS name. A DNS query for every attempt would be needed to break the hash.

Secondly, salting may be performed. In particular, verifiable identifiers may be salted before being hashed. This means that the association can only be verified when the verifiable identifier (for example, e-mail address), domain and salt are all known.

### Verifiable Identifiers

In terms of verifiable identifiers, examples described herein make no specific determination about what is considered a verifiable identifier. The domain verification protocol may be intended for e-mail addresses and telephone numbers. However, it may be used for any unique identifier that is verifiable.

In examples, e-mail addresses are trimmed of white space and down-cased before being used as verifiable identifiers.

In examples, telephone numbers are in E.164 format (e.g. +441234567890) before being used as verifiable identifiers.

### DNS Names

In terms of DNS names, the domain verification protocol uses DNS names to create and verify associations between authorised parties and domain names. As explained above, associations may be hidden or secret.

In terms of hidden associations, to create or verify a hidden association between an authorised party at user@example.com and domain name dvexample.com, a DNS name with a base 36 encoded SHA-256 digest of the e-mail address may be used as the first label in the DNS name, and _dv is used as the second label, as follows:

4i7ozur385y5nsqoo0mg0mxv6t9333s2rarxrtvlpag1gsk8pg._dv.dv
example.com

A SHA-256 digest is 64 characters. However, a DNS label can comprise a maximum of 63 characters. The base 36 encoding reduces the number of characters of the SHA-256 digest from 64 to 50 characters. The base 36 encoded SHA-256 digest can therefore be used as a DNS label.

However, the use of base 36 encoding and/or the use of SHA-256 is optional.

For example, a SHA-256 digest could be included, without base conversion, across more than one DNS label.

A hidden association can only be verified by those who know where to look. This is those who know the domain name and e-mail address, and suspect an association between the two.

In terms of secret associations, to create or verify a secret association between an authorised party at user@example.com and domain name dvexample.com, a DNS name with a base 36 encoded SHA-256 digest of the salted e-mail address is used as the first label in the DNS name, and _dv is used as the second label.

It is not sufficient to know only the e-mail address and domain name to verify a secret association. The salt also needs to be known.

Assume a salt of:

0E)W2!CohH2=?jF*5Sdjia4s(pnypXQZ3Cy!Duco

The DNS name required to create or verify this association would be:

4bg9vz90id4ah55y8pgbo0szimo7zjrhwxldkgfx04dyz24j7c._dv.dv
example.com

Secret associations involve a salt being set and a method to retrieve the salt.

In terms of salt references, to enable secret associations for dvexample.com, a salt reference record is created or retrieved. In this example, this uses the DNS name _dv.dvexample.com

In terms of salting methods, in examples, the salt is always added before the verifiable identifier (vid), for example: #{salt}#{vid}. However, the salt and verifiable identifier could be combined in a different manner in other examples.

Assume a salt of:

0E)W2!CohH2=?jF*5Sdjia4s(pnypXQZ3Cy!Duco

Also assume a vid of: user@example.com.

The string to be hashed would therefore be:

0E)W2!CohH2=?jF*5Sdjia4s(pnypXQZ3Cy!Ducouser@example.com

It can be seen that, in these examples, the verifiable identifier must be known to the verifying entity before the DNS query can be generated. This is because the verifiable identifier is used (potentially with a salt) to generate the hashed data, which is then used (potentially after being base 36 encoded) to construct the domain name to be used for the DNS query.

This differs from a process in which the verifiable identifier does not have to be known for a DNS query (to be used to perform verification associated with a domain name) to be constructed and transmitted.

### Record Contents

In terms of record contents, domain verification records may be written in Minimal Object Description Language (MODL). MODL is a JSON-like data serialisation language designed for efficient DNS storage. In examples, all domain verification records start with @dv=X; where X is a version number.

The content of association records defines the permissions of an authorised party.

A salt reference record lists references for the salts used in secret associations for a domain:

@dv=1;salts=[(s=salts.domainverification.org;ids=[342c208
d-0523-4d22-b7dd-32952dbeace2]);(s=example.com;ids=[90797a69-
205b-4a35-88fe-8a186392ea15])]

In this example, @dv=1 indicates this is a domain verification record and the version number, and salts=[ . . . ] indicates an array of salts used for domain verification records on this domain.

In this example, (s=salts.domainverification.org; ids=[342c208d-0523-4d22-b7dd-32952dbeace2]) is a MODL map containing two keys. One key defines the salt store, (s), and the other defines the ids of the salts used.

In this example, (s=example.com; ids=[90797a69-205b-4a35-88fe-8a186392ea15]) is as above, but setting a different salt store and salt ID.

Using these references, each salt with each salt store can be looked up. More detail on salt lookup is provided below.

Various other keys may be valid in an association record.

The key d may be an optional key. The key d may provide a description of the authorised party an association relates to. Since the only reference to the authorised party is a hashed verifiable identifier, it can be helpful to store descriptive text to make it easier to maintain domain verification records. For the very privacy conscious, the verifiable identifier should not be stored in clear text since, although it could be assumed anyone that can query the record already knows the verifiable identifier, the security of DNS transport varies depending on resolver implementation, and resource records are routinely stored in resolver caches.

The key h may be a required key. The key h may give the (optionally, salted and) hashed verifiable identifier. This enables a domain verification library to ensure the resource record is intended for the DNS name queried and not a wildcard resource record, or otherwise incorrectly created record.

The key e may be an optional key. The key e may give the expiry date, for example in YYYYMMDD format. This sets an association expiry date. This may be useful when granting a third party authorisation for temporary access.

### Record Lookup

In terms of record lookup, domain verification records are found using DNS queries specifying the TXT record type.

In terms of association lookup, a query is made for a hidden association record first using the specified DNS name for a hidden association:

```
  dig
4i7ozur385y5nsqoo0mg0mxv6t9333s2rarxrtvlpag1gsk8pg._dv.dvexamp
le.com TXT +short
  -> “@dv=1;s=[all]”
```

If the query fails or if an invalid record is returned, a failover query is made for a secret association record. Before a query for a secret association record is made, a salt reference lookup and subsequent salt lookup are first made.

Once the salt has been retrieved, a secret association can be queried using the specified DNS name for a secret association:

```
  dig
4bg9vz90id4ah55y8pgbo0szimo7zjrhwxldkgfx04dyz24j7c._dv.dvexamp
le.com TXT +short
  -> “@dv=1;s=[all]”
```

If multiple salts have been used for secret associations on the domain, this process is repeated for each salt until either a valid domain verification record is found or no valid domain verification record is found. In this example, the process is repeated in the order defined in the array.

In terms of salt reference lookups, a salt reference lookup may be made as follows:

```
  dig _dv.dvexample.com TXT +short
  ->
“@dv=1;salts=[(s=salts.domainverification.org;ids=[342c208d-
0523-4d22-b7dd-32952dbeace2])]”
```

For each salt reference returned in the salt reference record, a salt lookup may be performed.

### Permissions

Permissions, which may also be referred to herein as “verification permissions” may be set by service type, provider and service name. Each permission is in addition to the last.

In terms of permissions by service type, permissions for service types are defined in an array using the key s, for example s=[seo; marketing], with various values recognised. all grants permissions to all services. seo gives permission for the domain to be verified for SEO-related services. marketing gives permission for the domain to be verified for marketing services. email gives permission for the domain to be verified for email services. storage gives permission for the domain to be verified for online storage services.

In terms of permissions by service provider, permissions for service providers are in addition to any settings above and may be defined in an array using the key p, for example: p=[provider1.com; provider2.com].

In terms of permissions by service name, permissions for service names are in addition to any settings above and may be defined in an array using the key sn, for example:

sn=[service1.provider3.com].

By way of an example, if a domain name owner wanted to give permission to their SEO agency to verify their domain, they could use the category seo to give their SEO agency the ability to verify the domain on a service that identifies itself as SEO-related, and could use the service name analytics.google.com for Google Analytics. The domain verification record for such an example may be as follows:

@dv=1;s=[seo];sn=[analytics.google.com]

In terms of self-certification, service providers certify themselves as a provider of a certain service type, or service name. The interests of domain owners and service providers are aligned since neither wants someone to have incorrect permissions over a domain name.

### Salt Lookup

In terms of salt lookup, authorised service providers may look up salts in a salt store using a salt lookup service.

### WORKED EXAMPLES

Several worked examples will now be provided. In these examples, associations are created between multiple authorised parties and the domain dvexample.com.

### Worked Example 1—Hidden Association

In this example, a hidden association is created between an authorised party identified by the email address someone@example.com and the domain name dvexample.com. The authorised party is allowed to verify the domain for all marketing services and a service called hosting by the provider serviceprovider.com.

In terms of creating the record, for a hidden association, one domain verification record is created. The DNS name is derived, in this example, as indicated by the following pseudo code representation:

```
  SHA-256(“someone@example.com”)
  ->
72497f475e4f76d0b28f57c73a084ece576d170874eba3ee2609d9afe4b71a
ab
  Base-
36(“72497f475e4f76d0b28f57c73a084ece576d170874eba3ee2609d9afe4
b71aab”)
  -> 2ujmt78p82bjs6asang9sy569ykmm1dcg171ssnhgjrh9wlmsr
  Suffix with “._dv.dvexample.com”
  ->
2ujmt78p82bjs6asang9sy569ykmm1dcg171ssnhgjrh9wlmsr._dv.dvexamp
le.com
```

By creating a DNS TXT record at the above location, an association is created between the verifiable identifier someone@example.com and the domain name dvexample.com. To set permissions for this authorised party to verify the domain on all services in the marketing category and a service named hosting for the provider serviceprovider.com, the following content is used for the DNS TXT record:

@dv=1;s=[marketing];sn=[hosting.serviceprovider.com]

Additional information about syntax for permissions is described herein.

In terms of performing the lookup, to look up a hidden association between the verifiable identifier someone@example.com and the domain name dvexample.com, the same DNS name as set out above is queried:

```
  dig
2ujmt78p82bjs6asang9sy569ykmm1dcg171ssnhgjrh9wlmsr._dv.dvexamp
le.com TXT +short
  -> “@dv=1;s=[marketing];sn=[hosting.serviceprovider.com]”
```

### Worked Example 2—Secret Association

In this example, a secret association is created between an authorised party identified by the email address anonymous@example.com and the domain name dvexample.com. The authorised party may be allowed to verify the domain for all services.

In terms of creating the records, for a secret association, two domain verification records are created. Firstly, a salt reference record is created. The contents of this record depend on the tool used to create the record. This example uses a bespoke tool, provided in accordance with examples, to create a record. In this example, the salt reference record is created at _dv.dvexample.com with the following content:

@dv=1;salts=[(s=salts.domainverification.org;ids=[342c208
d-0523-4d22-b7dd-32952dbeace2])]

A second record is created using a DNS name derived from a SHA-256 digest of the salted verifiable identifier.

In this example, the salt is:

0E)W2!CohH2=?jF*5Sdjia4s(pnypXQZ3Cy!Duco

The salt is prefixed to the verifiable identifier, the resulting string is hashed, and the digest is base 36 encoded as the first DNS label. _dv is used as the second label. The full DNS name is:

3p4gp4roel51tbkbgt6ik31c5wbqhubag5ees9zgksqdasvp9i._dv.dv
example.com

The contents of the record are:

@dv=1;s=[all]

In terms of using multiple salt stores, sometimes association records will be created by multiple parties and so references may be stored for multiple salts. Each may be stored in an array:

@dv=1;salts=[(s=salts.domainverification.org;ids=[342c208
d-0523-4d22-b7dd-32952dbeace2]);(s=example.com;ids=[90797a69-
205b-4a35-88fe-8a186392ea15])]

In terms of performing the lookups, the first step is to query the hidden association record (see above). If that query fails or the returned record is invalid, the next step is to query the salt reference record.

The salt reference record may be queried as follows:

```
  dig _dv.dvexample.com TXT +short
  ->
″@dv=1;salts=[(s=salts.domainverification.org;ids=[342c208d-
0523-4d22-b7dd-32952dbeace2])
```

The salts array is used, and each object is worked through to make a salt lookup. In this example, an HTTP POST is sent to the address

```
salts.domainverification.org, and a token and saltID are passed:
  curl https://salts.domainverification.org -d
“token=#{YOUR_TOKEN_HERE}&saltId=342c208d-0523-4d22-b7dd-
32952dbeace2”
  -> {“salt”:“0E)W2!CohH2=?jF*5Sdjia4s(pnypXQZ3Cy!Duco”}
```

There is now the domain (dvexample.com), the verifiable identifier (anonymous@example.com) and the salt used for secret association records on this domain (0E)W2!CohH2=?jF*5Sdjia4s (pnypXQZ3Cy!Duco). A query can be made for a secret association record using a DNS name derived as indicated by the following pseudo code representation:

```
  Prefix “anonymous@example.com” with
“0E)W2!CohH2=?jF*5Sdjia4s(pnypXQZ3Cy!Duco”
  ->
0E)W2!CohH2=?jF*5Sdjia4s(pnypXQZ3Cy!Ducoanonymous@example.com
  SHA-
256(“0E)W2!CohH2=?jF*5Sdjia4s(pnypXQZ3Cy!Ducoanonymous@example
.com”)
  ->
945df6dbd91cd5d91cb7896c4f42904a618f7e62997898091ef63919b6e0e5
a6
  Base-
36(“945df6dbd91cd5d91cb7896c4f42904a618f7e62997898091ef63919b6
e0e5a6”)
  -> 3p4gp4roel51tbkbgt6ik31c5wbqhubag5ees9zgksqdasvp9i
  Suffix with “._dv.dvexample.com”
  ->
3p4gp4roel51tbkbgt6ik31c5wbqhubag5ees9zgksqdasvp9i._dv.dvexamp
le.com
```

To verify the secret association and fetch permissions, the record is queried in DNS:

```
  dig
3p4gp4roel51tbkbgt6ik31c5wbqhubag5ees9zgksqdasvp9i._dv.dvexamp
le.com TXT +short
  -> “@dv=1;s=[all]”
```

### Salt Store Specification

In terms of URL, in examples, the URL of the salt store only responds over HTTPS; HTTP requests fail and do not redirect.

In terms of the method, requests are made using the HTTP POST method.

In terms of parameters, token is a service provider's authorised access token, and saltId is the ID of the salt being looked up.

In terms of responses, the salt store should return a JSON object and an HTTP status code. The status returned matches those listed below.

In terms of success, the JSON object for a successful lookup returns 200 status and includes at least the key salt with the salt string returned as the value of this key. Other data may be returned depending on implementation:

{“salt” : “X”}

In terms of failure, the JSON objects returned for error are suggestions and may vary depending on implementation.

Regarding no token, if the token is not provided, a 401 status and the following JSON are returned:

{“error”: “No token, not authorised”}

In terms of token not found or not authorised, if the token is not found or not authorised, a 401 status and the following JSON are returned:

{“error”: “Token not authorised”}

In terms of no salt, if the saltId is not provided, a 400 status and the following JSON are returned:

{“error”: “No saltId”}

In terms of an example salt, if the saltId provided is the example given in any documentation, a 404 status and the following JSON are returned:

{“error”: “Salt not found, this salt ID is only used for
examples”}

In terms of salt not found, if the saltId provided is not found in the salt store, a 404 status and the following JSON are returned:

{“error”: “Salt not found”}

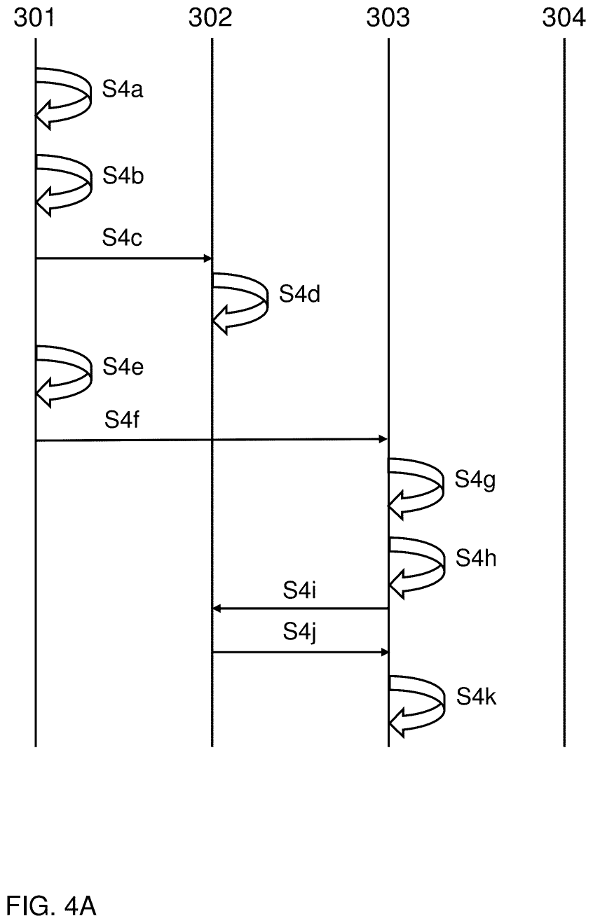

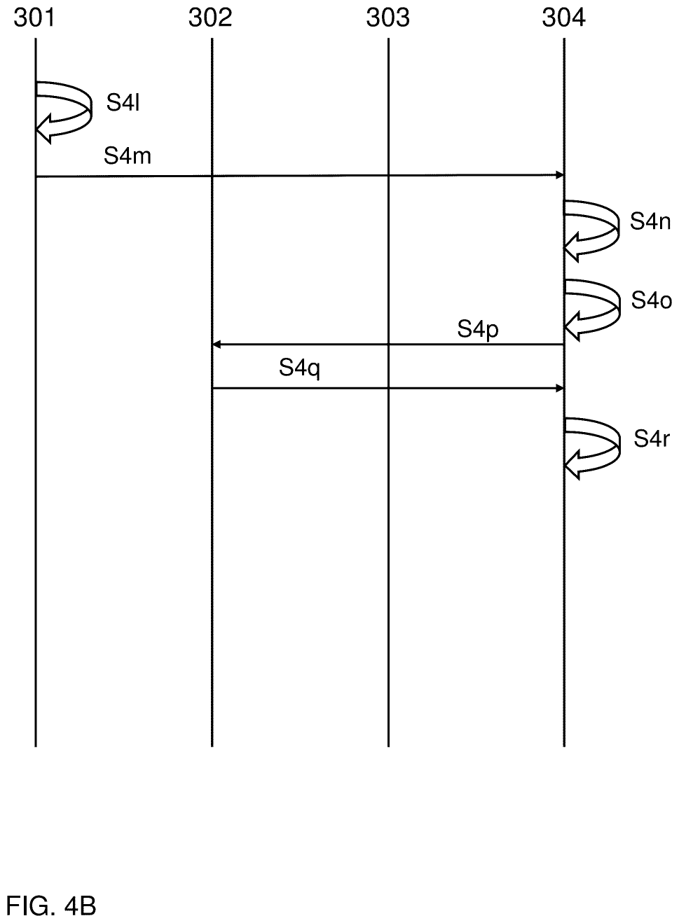

Referring to FIG. 4, there is shown an example of a method 400 of performing verification in a hierarchical domain name system. In this example, the hierarchical domain name system comprises the DNS. In this example, the method 400 enables domain name verification to be performed in the example data communications network 300 described above with reference to FIG. 3. In this example, the method 400 corresponds to a user of the user device 301 enabling the first and second service provider apparatuses 303, 304 to perform verification associated with a domain name using one or more verifiable identifiers. In this example, the first and second service provider apparatuses 303, 304 receive the verifiable identifier(s) and domain name from the user device 301 via the network 305. In this specific example, the domain name is “example.com” and the verifiable identifier is the e-mail address of the user “username@example.com”. In this specific example, the name server 302 is the authoritative name server for “example.com”. In this example, the name server 302 is also the authoritative name server for the below-described sub-domain of “example.com”, namely “59614f92093fc9fef50673bc160fd808623b17bd._dv.example.com”. However, the authoritative name servers for “example.com” and the sub-domain could be different in other examples.

At item S4a, the user device 301 obtains the e-mail address. The user device 301 may obtain the e-mail address in various different ways. For example, the user may enter the e-mail address via a user interface of the user device 301, the user device 301 may retrieve the e-mail address from memory of the user device 301, the user device 301 may obtain the e-mail address from a remote source, etc.

At item S4b, the user device 301 hashes the e-mail address using a hash function. In this example, the hash function is SHA-1, which maps the input data “username@example.com” to hashed data “59614f92093fc9fef50673bc160fd808623b17bd”. However, as explained above, different hash functions could be used in other examples. In some scenarios, a more secure hash function may be used for example. Also, as explained above, the input data may comprise additional data, such as a prepended salt, in other examples. In this example, the hashed data obtained at item S4b corresponds to first data as described herein. As indicated above, in this example, the input data to the hash function corresponds to all of the data, in this example only the e-mail address, that is mapped onto the hashed data. If, in another example, the e-mail address were combined with other data (for example, a telephone number and/or salt) and the combination of the e-mail address and other data were hashed, then the input data would correspond to the combination of the e-mail address and the other data (i.e. all of the data being hashed). In this example, the first data is useable by the first and second service provider apparatuses 303, 304 to perform verification associated with the domain name. As such, in this example, the first data corresponds to shared verification data, as opposed to service-provider-specific authorization codes.

At items S4c and S4d, the user device 301 causes a new sub-domain to be created. A new zone file may be created for that new sub-domain or an existing zone file may be used. In this example, the new sub-domain comprises the hashed data. In this specific example, the new subdomain is: “59614f92093fc9fef50673bc160fd808623b17bd._dv.example.com”. As such, in this example, the new sub-domain comprises the domain name to be verified, namely “example.com” and two labels preceding the domain name to be verified. A first label of the two labels comprises the hash of the input data. As explained above, the hash could be included across multiple labels in other examples. A second label of the two labels is “_dv”. The second label could take a different form in other examples.

The authoritative name server 302 for the domain name “59614f92093fc9fef50673bc160fd808623b17bd._dv.example.com” may create a zone file for the new domain name. This may, for example, involve the user triggering creation of the zone file via the user device 301. However, as explained above, an existing zone file may instead be used.

In this example, the first data is also stored in a TXT resource record in the zone file. In other words, in addition to being part of the domain name “59614f92093fc9fef50673bc160fd808623b17bd._dv.example.com”, the first data “59614f92093fc9fef50673bc160fd808623b17bd” is also stored in a TXT resource record for the domain name “59614f92093fc9fef50673bc160fd808623b17bd._dv.example.com”. For example, the user may create a new TXT resource record specifically for the first data.

As such, in this example, a verifiable identifier (namely, the e-mail address “username@example.com”) associated with an entity (namely, the user) associated with a domain name (namely, the domain name “example.com”) is mapped (at item S4b) onto hashed data (namely, the first data) using a hash function (namely, SHA-1) and a resource record is created describing a new domain name comprising the hashed data (at items S4c and S4d).

At item S4e, the user device 301 obtains the e-mail address and the domain name. The user device 301 may obtain the e-mail address and the domain name in various different ways. For example, the user device 301 may have already obtained one or both of the e-mail address and the domain name from the user. Alternatively or additionally, the user device 301 may prompt the user for one or both of the e-mail address and the domain name at item S4e.

At item S4f, the user device 301 transmits the e-mail address and the domain name to the first service provider apparatus 303 via the network 305. In this example, the user device 301 does not transmit the first data to the first service provider apparatus 303 at item S4f. As such, in this example, the first service provider apparatus 303 receives the e-mail address and the domain name from the user device 301 via the network 305. This differs from the first service provider apparatus 303 obtaining the e-mail address and the domain name in another manner, such as the first service provider apparatus 303 generating the e-mail address and the domain name.

While, in this example, the first service provider apparatus 303 receives the e-mail address and the domain name from the user device 301 via the network 305 after the e-mail address has been hashed (item S4b) and the first data has been stored by the authoritative name server 302 (items S4c, S4d), the first service provider apparatus 303 could receive the e-mail address and the domain name at a different time, for example before the e-mail address has been hashed (item S4b) and/or the first data has been stored by the authoritative name server 302 (items S4c, S4d). Further, while, in this example, the first service provider apparatus 303 receives the e-mail address and the domain name together, the e-mail address and the domain name could be received separately in other examples.

The e-mail address and the domain name are known to at least one entity in addition to the first service provider apparatus 303 (and the service provider associated with the first service provider apparatus 303). In particular, the e-mail address and the domain name are known to the user of the user device 301 and, as will be described below, the second service provider apparatus 304. The e-mail address and the domain name may be known to one or more further entities. Examples of such further entities include, but are not limited to, hosting companies, the public, Registrars etc.

In this example, the first service provider apparatus 303 verifies the e-mail address received, from the user device 301, via the network 305, at item S4g. In this example, verifying the e-mail address corresponds to the first service provider apparatus 303 verifying that the user is in control of the e-mail address. More generally, verifying contact information may correspond to verifying that an entity providing the contact information is in control of the contact information. For example, the first service provider apparatus 303 may cause an e-mail with a verification link to be transmitted to the e-mail address. Upon the user following the verification link, the first service provider apparatus 303 can verify that the user is in control of the e-mail address. In this example, the verification associated with the domain name is dependent on verifying the e-mail address. In this example, if the e-mail address is not successfully verified, then the verification associated with the domain name fails. In this example, if the e-mail address verification is successful, then the verification associated with the domain name can succeed, but at least one further check is made as described below. Where, for example, the contact information comprises a telephone number of the user, verification of the telephone number may involve the first service provider apparatus 303 causing an automated call to be placed to the user with a verification number, a Short Messaging Service (SMS) message to be sent to the user with the verification number, etc. Upon the user providing the same verification number back to the first service provider apparatus 303, responding to the SMS message with a predetermined response etc, the first service provider apparatus 303 can verify the telephone number on the basis that the user is in control of the telephone number.

At item S4h, the first service provider apparatus 303 hashes the e-mail address (which the first service provider apparatus 303 received from the user device 301 via the network 305 at item S4f) using SHA-1 to mirror the hash function used by the user device 301. The user device 301 may indicate to the first service provider apparatus 303 which hash function should be used by the first service provider apparatus 303.

Although in this specific example, the input data hashed at item S4h consists of the email-address, the input data may comprise the e-mail address and may also comprise additional data (for example, a salt) in other examples.

As such, in this example, the input data (namely, the e-mail address) is known to at least one entity in addition to the first service provider apparatus 303. For example, the input data is also known to the user of the user device 301. This differs from the input data being known only to the first service provider apparatus 303. Where, for example, the e-mail address were combined with a unique secret known only to the first service provider apparatus 303 and the combined data were used as input data, such input data (as a whole) would be considered to be known only by the first service provider apparatus 303. In such an example, the input data (as a whole) would not be known to the user of the user device 301, for example, since the unique secret component of the input data would be known only to the first service provider apparatus 303 and not also to the user of the user device 301.

At item S4i, the first service provider apparatus 303 transmits, and the authoritative name server 302 receives, a DNS query comprising the hashed data and the domain name in association with which verification is being performed via the network 305. In this example, the DNS query is the domain name for “59614f92093fc9fef50673bc160fd808623b17bd._dv.example.com”. Although in this example, the authoritative name server 302 receives the DNS query from the first service provider apparatus 303, the authoritative name server 302 may not receive the DNS query from the first service provider apparatus 303. For example, where a response to the DNS query has previously been cached, a cached version of the response may be returned to the first service provider apparatus 303. The cached version of the response may correspond to a response to a previous DNS query from the first service provider apparatus 303 or may correspond to a response to a previous DNS query from other apparatus in the network 300.

In this example, the first service provider apparatus 303 requests only TXT resource records, as opposed to any type of resource record. This may be achieved by the first service provider apparatus 303 including the resource record type identifier “TXT” in the DNS query. Requesting only TXT resource records allows the DNS query and response to be handled relatively quickly compared to any type of resource record being requested. Also, less data is communicated via the DNS by requesting TXT resource records only. Since the data used by the first service provider apparatus 303 to perform verification is in TXT resource records only, verification may still be performed while limiting data usage in the DNS. An example form of the DNS query of item S4i, which includes the domain name (example.com) is:
dig 59614f92093fc9fef50673bc160fd808623b17bd._dv.example.com TXT

At item S4j, the authoritative name server 302 transmits, and the first service provider apparatus 303 receives, a response to the DNS query of item S4i via the network 305. As indicated above, in examples in which a previous response to a DNS query for the domain has been cached, the first service provider apparatus 303 may receive the response to the DNS query of item S4i from elsewhere in the network 300.

The response of item S4j comprises the hashed data and the domain name in association with which the verification is being performed. The DNS response of item S4j may comprise other data. In this example, only TXT resource records are returned since only TXT resource records were requested at item S4i. In this example, the first service provider apparatus 303 receives the e-mail address and the domain name from the user device 301 via the network 305 (item S4f), transmits the DNS query to the authoritative name server 302 via the network 305 (item S4i) and receives the response to the DNS query from the authoritative name server 302 via the network 305 (item S4j). It will be appreciated that the first service provider apparatus 303 can use different connections for communications with the user device 301 and the authoritative name server 302 with such communications taking place via the network 305. Different connections may correspond to different communications protocols being used, different physical and/or logical parts of the network 305 being used, etc.

At item S4k, the first service provider apparatus 303 determines whether or not the verification is successful based at least in part on the response received at item S4j. In this example, the response of item S4j therefore enables the recipient of the response (in this example, the first service provider apparatus 303) to determine the result of the verification associated with the domain name. In this example, the result of the verification is that verification is successful. As indicated above, in this example, the verification is based further on verifying the e-mail address. In other examples, the result of the verification could be that verification is unsuccessful.

Items S4l to S4r correspond closely to items S4e to S4k respectively, except that the verification is performed by the second service provider apparatus 304 instead of the first service provider apparatus 303. In particular, at items S4l and S4m, the user device 301 obtains and transmits the e-mail address and domain name to the second service provider apparatus 304 via the network 305. At item S4n, the second service provider apparatus 304 constructs a DNS query using the domain name and based at least in part on hashing the e-mail address. In this example, the second service provider apparatus 304 hashes the e-mail address using SHA-1, which maps “username@example.com” to “59614f92093fc9fef50673bc160fd808623b17bd”. As such, both the first and second service provider apparatuses 303, 304 map the same input data, namely “username@example.com”, to the same hashed data, namely “59614f92093fc9fef50673bc160fd808623b17bd”, using the same hash function, namely SHA-1. At item S4o, the second service provider apparatus 304 verifies the e-mail address. At item S4p, the second service provider apparatus 304 transmits a DNS query to the authoritative name server 302 via the network 305. At item S4q, the authoritative name server 302 transmits a response to the second service provider apparatus 304 via the network 305 (assuming a previous response to a DNS query for the domain name has not been cached elsewhere in the network 305). At item S4r, the second service provider apparatus 304 checks whether the response received at item S4q is an expected response. In this example, the response received at item S4q is a valid response, so the result of the check at item S4r is that the verification is successful based on the result of the check at item S4r. If the response of item S4q were, for example, an NXDOMAIN (non-existent domain) response, or another predetermined type of response, the result of the check at item S4r may be that the verification is unsuccessful based on the result of the check at item S4r.

As such, in this example, the authoritative name server 302 receives (at item S4i), from the first service provider apparatus 303 associated with the first service provider, a first domain name system query comprising a domain name (namely, “59614f92093fc9fef50673bc160fd808623b17bd._dv.example.com”). In this example, the domain name comprised in the first domain name system query includes both the hashed data and the domain name in association with which verification is being performed. The authoritative name server 302 transmits (at item S4j), to the first service provider apparatus 303, a first response in response to the first domain name system query. The first response comprises verification data (namely, the first hashed data). The verification data (namely, the first hashed data) has been derived deterministically (in this example, using SHA-1) based on: (i) an identifier (namely, in this example, the e-mail address) associated with an entity associated with the domain name and/or (ii) data provided by an entity associated with the domain name to another entity (examples of such data are provided below). The authoritative name server 302 receives (at item S4p) from the second, different service provider apparatus 304 associated with the second, different service provider, a second domain name system query comprising the same domain name as is in the first domain name system query (namely, “59614f92093fc9fef50673bc160fd808623b17bd._dv.example.com”). The authoritative name server 302 transmits (at item S4q), to the second service provider apparatus 304, a second response in response to the second domain name system query. The second response also comprises the verification data (namely, the first hashed data).

It will be understood that this example differs from known, service-provider-led techniques in which each service provider provides a user with a service-provider-specific authorization code and requests the user to store each such authorization code in a zone file for the domain name. In contrast, in this example, the storage of the verification data is user-led. In particular, in this example, the user may have caused a resource record describing a domain name comprising the hashed data to be created before the first and second service provider apparatuses 303, 304 have generated the hashed data. The user may, for example, cause the resource record to be created once and may then enable multiple different verifying entities to perform verification without having to create or edit the resource record again. This is achieved, in this example, by the user providing the first and second service provider apparatuses 303, 304 with the input data to be used by the first and second service provider apparatuses 303, 304 to derive the hashed data in order to be able to query the domain name comprising the hashed data. This differs from verifying entities providing the user with authorization codes to be stored in the zone file, particularly where different verifying entities provide different authorization codes.

This example also differs from the above-described verification in which hashed data is only stored in TXT record contents. In particular, in the above-described verification, hashed data may only be stored at, for example, the DNS name “authority.example.com” with the TXT record contents including the hash: 59614f92093fc9fef50673bc160fd808623b17bd.

Examples described herein may store the hash in the DNS name itself, for example: 59614f92093fc9fef50673bc160fd808623b17bd.example.com.

This makes it much harder to try to break the hash. In particular, when using the hash in the DNS label itself, someone trying to break the hash would have to perform a DNS query for each hash-breaking attempt. For example, to attempt to break an e-mail-address-derived hash for a given domain name, each email address in an extremely large list would need to be hashed and then queried as a sub-domain of the given domain name. It is, in practice, computationally unfeasible to use this method to establish links between e-mail addresses and domain names at scale. In contrast, in other implementations, e-mail-address-derived hashes could be harvested, since they are always available at a standard location. These could then be compared against pre-computed hashes for that extremely large number of e-mail addresses.

Examples described herein enable a DNS provider to create an association between a first entity, Entity1, and a second entity, Entity2. An ID for the first entity, Entity1 ID, may be hashed, or salted and hashed. The result may be stored in a DNS label of a domain of the second entity, Entity2 Domain. Examples described herein also enable a service provider to verify an association between a first entity, Entity1, and a second entity, Entity2. An ID for the first entity, Entity1 ID, may be hashed or salted and hashed. The result may be included as a DNS label in a DNS query.

An Entity ID may be any unique ID. The Entity ID may comprise a telecommunications identifier, such as an e-mail address or telephone number. The Entity ID may comprise a non-telecommunications-based identifier, such as a driving license number or passport number.

An Entity Domain may represent anything. For example, the Entity Domain may represent a company, a role at a company, property, etc. This may be effective for proving ownership and relationships.

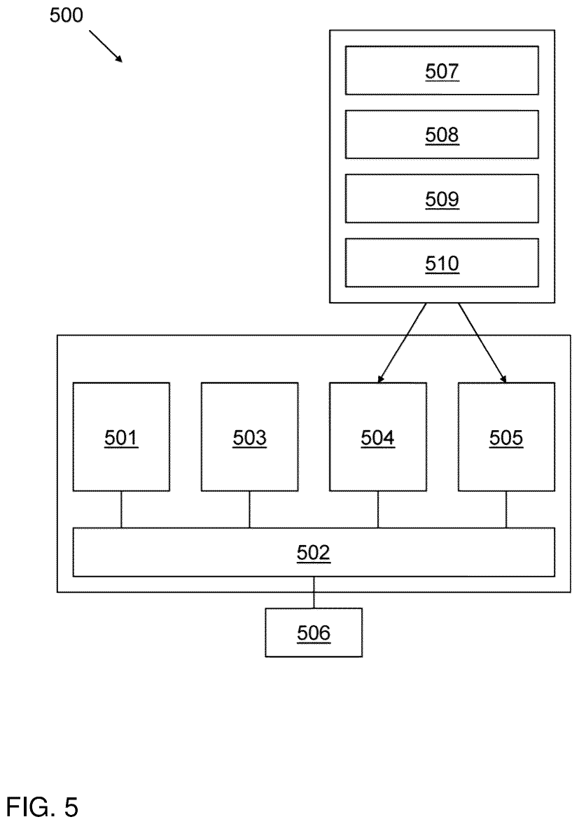

Referring to FIG. 5, there is shown a block diagram of an apparatus 500. The apparatus is configured to process data. Such data processing may involve performing verification associated with a domain name and/or enabling such verification to be performed. The apparatus 500 may, for example, comprise one or more of the apparatuses 301, 302, 303, 304 described above with reference to FIG. 3.

The apparatus 500 may take various different forms. Examples of forms of the apparatus 500 include, but are not limited to, mobile telephony device, a satellite navigation system, a smart television set, a desktop computer, a laptop computer, a server, a name server, a tablet computing device, a router etc.

In this example, the apparatus 500 comprises one or more processors 501 configured to process information and/or instructions. The one or more processors 501 may comprise a central processing unit (CPU). The one or more processors 501 are coupled with a bus 502. Operations performed by the one or more processors 501 may be carried out by hardware and/or software.

In this example, the apparatus 500 comprises computer-useable volatile memory 503 configured to store information and/or instructions for the one or more processors 501. The computer-useable volatile memory 503 is coupled with the bus 502. The computer-useable volatile memory 503 may comprise random access memory (RAM).

In this example, the apparatus 500 comprises computer-useable non-volatile memory 504 configured to store information and/or instructions for the one or more processors 501. The computer-useable non-volatile memory 504 is coupled with the bus 502. The computer-useable non-volatile memory 504 may comprise read-only memory (ROM).

In this example, the apparatus 500 comprises one or more data-storage units 505 configured to store information and/or instructions. The one or more data-storage units 505 are coupled with the bus 502. The one or more data-storage units 505 may for example comprise a magnetic or optical disk and disk drive.

In this example, the apparatus 500 comprises one or more input/output (I/O) devices 506 configured to communicate information to the one or more processors 501. The one or more I/O devices 506 are coupled with the bus 502. The one or more I/O devices 506 may comprise at least one network interface. The at least one network interface may enable the apparatus 500 to communicate via one or more data communications networks. Examples of data communications networks include, but are not limited to, the Internet, a Local Area Network (LAN) and a wide area network (WAN). The one or more I/O devices 506 may enable a user to provide input to the apparatus 500 via one or more input devices (not shown). Examples of input devices include, but are not limited to, a keyboard and a mouse. The one or more I/O devices 506 may enable information to be provided to a user via one or more output devices (not shown). Examples of output devices include, but are not limited to, a computer monitor and a display screen.

Various other entities are depicted for the apparatus 500. For example, when present, an operating system 507, a data processing system 508, one or more modules 509, and data 510 are shown as residing in one, or a combination, of the computer-usable volatile memory 503, computer-usable non-volatile memory 504 and the one or more data-storage units 505. The data processing system 508 may be implemented by way of computer program code stored in memory locations within the computer-usable non-volatile memory 504, computer-readable storage media within the one or more data-storage units 505 and/or other tangible computer-readable storage media.

Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program.

It will be appreciated that the apparatus 500 may comprise more, fewer and/or different components from those depicted in FIG. 5.

The above embodiments are to be understood as illustrative examples. Further embodiments are envisaged.

In examples described above, the user device 301 hashes the e-mail address at item S4b. In other examples, the e-mail address is hashed outside of the user device 301. For example, the hosting company for the domain name may enable the user to provide the e-mail address to the hosting company and the hosting company may generate the hashed data on behalf of the user. In some such examples, the user may not use the user device 301 to cause the new sub-domain to be created. For example, the user may be able to contact the hosting company without using the user device 301 and request the hosting company to create the sub-domain and domain verification record. The user may provide the hosting company with the e-mail address and/or the hashed data (and/or other input data). The user may, alternatively or additionally, be able to provide the Registrar of the domain name with the e-mail address (and/or other input data) during registration of the domain name with the Registrar, and the Registrar may be able to create the sub-domain on behalf of the user when registering the domain name.

In examples described above, the first service provider apparatus 303 verifies the e-mail address in response to being provided with the e-mail address at item S4f. However, the first service provider apparatus 303 may verify that the user is in control of the e-mail address (and/or any other contact information) in a different manner. For example, the first service provider apparatus 303 may verify that the user is in control of the e-mail address in response to receiving the response at item S4j, or otherwise.

In examples described above, the example e-mail address (username@example.com) includes the domain name (example.com) in association with which verification is being performed. However, the domain name component of the e-mail address may be different from the domain name in association with which verification is performed in other examples. For example, an example e-mail address (username@example.com) may be used to perform verification in association with another domain name (for example, “anotherexample.com”).

In examples described above, at items S4c and S4d, the user device 301 causes all of the hashed data derived from the input data to be used by the authoritative name server 302 in a domain name of a new sub-domain. In other examples, only part of the hashed data is used. The data that is used is, however, still considered to be hashed data and may correspond to the first hashed data described herein. For example, a predetermined number of characters of the hashed data may be used instead of the entire hashed data. Similarly, in examples described above, at items S4h and S4i, the first service provider apparatus 303 hashes the e-mail address and sends a DNS query comprising the entire hash of the e-mail address. In other examples, the first service provider apparatus 303 uses only a predetermined number of characters of the hashed data.

In examples described above, at item S4h, the first service provider apparatus 303 hashes the input data using the same hash function as that used by the user device 301. In some examples, the first service provider apparatus 303 may not know which hash function was used by the user device 301. In some such examples, the first service provider apparatus 303 may hash the input data using multiple hash functions and determine the result of the verification depending on whether or not any of the constructed DNS queries produces an expected response.

In examples described above, the DNS query is for a second domain name, rather than for a first domain name, where the first domain name is the domain name in association with which verification is being performed. In such examples, the second domain comprises the first domain name and the DNS query therefore comprises the first domain name. In such an example, the response to the DNS query is for the second domain name, rather than for the first domain name, and comprises both the first and second domain names. In such an example, the verification relies on a resource record at the second domain name, rather than at the first domain name. Further, where the authoritative name server for the second domain name is different from the authoritative name server for the first domain name, the burden on the authoritative name server for the first domain name resulting from the verification described herein being performed may be relieved.

As explained above, the authoritative name server for the second domain name may be the authoritative name server 302 (which is the authoritative name server for the first domain name (“example.com”)) or may be a different authoritative name server. Further, the response to the DNS query for the second domain name may not comprise the SPF data in the zone file for the first domain name (“example.com”). Unlike SPF, in some examples, verification data associated with a domain name is therefore not stored in and is not part of the root of the domain name. Instead, in this example, a sub-domain is used. The sub-domain may be reserved for verification purposes, or otherwise. This may help to keep the DNS efficient and uncluttered.

In examples described above, the input data comprises contact information, such as an e-mail address or telephone number. Another type of contact information is a social media identifier. The input data may, however, take different forms. For example, the input data may comprise bank details. In such an example, the hashed data may comprise hashed bank details of an entity (for example, an enterprise, an individual etc) associated with the domain name. A relying party may then verify that they have the correct bank details for the entity by performing a DNS query for a domain name comprising the hashed data. In such an example, the entity that creates the sub-domain is likely to be different from the entity that verifies the bank details. For example, a DNS administrator may create the sub-domain and a user (for example a customer) wishing to pay the entity may verify the bank details. In another example, a service provider provides a smart address book service by maintaining a database of contact information for a large number of entities, for example companies. Each company can create a sub-domain of their domain name based on the contact information. In some such examples, the user can contact the service provider with contact information presumed to be for the company and request that the service provider verify the contact information. The service provider can construct an appropriate DNS query for the company concerned. In such an example, the user is not asserting control over the contact information, but uses the service provider to verify that the contact information they have for the company is correct. Alternatively or additionally, the input data may comprise secret data, such as a password. As such, it will be understood that the relying party (who relies on the result of the verification) may be the same as or different from the entity that creates the sub-domain. This provides a flexible and versatile framework for verification using the DNS.

In examples described above, the input data includes the e-mail address and no other data (i.e. the input data consists of the e-mail address). In other examples, the input data may comprise multiple components. For example, the input data may comprise the e-mail address and the telephone number of the user. This may provide a higher degree of security in some examples. The resulting hashed data may also have the same size, irrespective of the size of the input data, such that no additional storage is used in storing the hashed data.

In examples described above, the same input data and, hence, hashed data is used by multiple, different service providers. In other examples, a user could use different input data for different service providers. For example, the user may create one sub-domain using a hash of their e-mail address and another using a hash of their telephone number. The user may provide the e-mail address to one service provider and their telephone number to another service provider. Both service providers would be able to perform validation successfully in association with the domain name, and the user would have a higher level of security in relation to the input data. However, this would increase the number of sub-domains.

Examples described above verify authority to manage a domain. However, if examples were used to, for example, verify ownership over a company, then verification may be performed in relation to an association between a domain and, for example, a passport number.

Examples described above interpret responses to DNS queries as part of the domain verification process. However, other examples may merely determine whether a resource record answer is received.

Performing verification associated with a domain name using a hierarchical domain name system as described above may be more efficient than performing such verification using a different mechanism. For example, using a hierarchical domain name system may result in less data being processed, less user interaction being involved and/or lower delays than performing such verification using a different mechanism. An example of such another mechanism is adding an HTML comment or meta tag including a random string to a homepage for a domain name, as described above. In addition, hashed data can enable verification data to be used by multiple different service providers while providing security in relation to the input data used to produce the hashed data. The input data is received via the network and can, in effect, be reused as input data for further verification performed by at least one further entity. This differs from the input data not being received via a network and, for example, being generated by a verifying entity solely for use by that verifying entity.

In examples, the input data comprises contact information. Contact information may be relatively private data and, as such, may serve as effective input data for verification purposes. Hashing contact information can preserve privacy in relation to the contact information. Where the hashed data is in a publicly accessible system, such as the DNS, such hashing may be particularly effective. Further, contact information may be verified as described herein to enhance further the verification.

In examples, the contact information comprises an e-mail address. An e-mail address may readily be verified and may be relatively private. For example, a user may choose not to publish their e-mail address widely and/or may readily be able to set up a dedicated e-mail address for the purposes of the verification described herein.

In examples, the contact information comprises a telephone number. A telephone number may readily be verified and may be relatively private. For example, a user may choose not to publish their telephone number widely.

In examples, the determining of the result of the verification is based further on verifying the contact information. This can enhance the reliability of the verification. In particular, if a third party were to obtain or guess the contact information and try to impersonate the entity in control of the contact information, the third party would not be able to verify the contact information since, for example, they would not receive a verification e-mail with a verification link if they are not in control of the e-mail address.

In examples, the hash function is a cryptographic hash function. This can provide enhanced security and privacy in relation to the input data which, as described herein, may be sensitive, confidential, secret, personal etc. In particular, a cryptographic hash function makes it difficult to obtain input data from given hashed data, even if the hash function used to hash the input data is known.

In some examples, the hash function is SHA-1. SHA-1 may, in examples, provide sufficient security with a reasonable resulting bit-length. A shorter bit-length of SHA-1, for example compared to SHA-2 or SHA-3, can result in more efficient storage and processing of the hashed data. However, a longer bit-length, such as with SHA-2 may provide enhanced security.

Examples may reduce the likelihood of corruption to a critical zone file associated with the first domain name and/or may relieve burden on an authoritative name server for the first domain in some examples.

In examples, authority for a sub-domain could be delegated to a name server other than the authoritative name server for the first domain, which may relieve burden on the authoritative name server for the first domain.

In examples, an authoritative name server for the first domain name is different from an authoritative name server for the second domain name. This can reduce the burden on the authoritative name server for the first domain name.

In examples, the domain name system query comprises a request for a TXT type of resource record only. This can provide efficient processing in that only data used for the verification is requested and retrieved.

In examples, the input data comprises bank details. As such, transactional mistakes and/or fraud may be managed. In particular, where verification fails, the bank details being verified may be checked and/or queried.

Various measures are provided in which processing is performed in relation to a resource record. Such processing may comprise creating the resource record, storing the resource record, requesting the resource record, providing the resource record, retrieving the resource record and so on. The resource record may be useable to perform verification associated with a first domain name. The resource record may be for a second, different domain name. The second domain name may comprise the first domain name. The second domain name may comprise at least one label preceding the first domain name. The at least one label preceding the first domain name may comprise first data. The first data may comprise or may be based on hashed data. The hashed data may have been derived based on input data having been mapped to the hashed data using a hash function. The input data may comprise at least one identifier. The identifier may comprise a verifiable identifier and/or another type of identifier.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of performing verification associated with a first domain name using a hierarchical domain name system, the method comprising:
transmitting a domain name system query comprising a second, different domain name, wherein the second domain name comprises the first domain name, wherein the second domain name comprises at least one label preceding the first domain name, wherein the at least one label preceding the first domain name comprises first data, wherein the first data comprises or is based on hashed data, the hashed data having been derived based on input data having been mapped to the hashed data using a hash function, and wherein the input data comprises at least one verifiable identifier; and
determining a result of the verification associated with the first domain name based at least in part on a response to the domain name system query.

2. (canceled)

3. (canceled)

4. The method of claim 1, wherein the input data consists of the at least one verifiable identifier.

5. The method of claim 1, wherein the input data comprises a salt.

6. The method of claim 5, wherein the salt is obtainable from a salt store.

7. The method of claim 5, wherein the salt precedes the at least one verifiable identifier in the input data.

8. The method of claim 5, wherein the at least one label preceding the first domain name comprises a first label comprising the first data and a second label comprising second data,
optionally wherein the first label precedes the second label in the second domain name.

9. (canceled)

10. The method of claim 8, wherein a resource record describing a third, different domain name comprises salt lookup data useable to obtain the salt, and wherein the third domain name comprises the second label followed by the first domain name,
optionally wherein the third domain name does not comprise the first label.

11. (canceled)

12. The method of claim 10, wherein the zone file describing the third domain name comprises further salt lookup data, the further salt lookup data being useable to obtain at least one further salt, the at least one further salt being useable to perform further verification associated with the first domain name.

13. The method of claim 1, wherein the at least one verifiable identifier comprises contact information,
optionally wherein the contact information comprises:
an e-mail address; and/or
a telephone number.

14. (canceled)

15. (canceled)

16. The method of claim 1, wherein the at least one verifiable identifier comprises a non-telecommunications-based identifier.

17. The method of claim 1, wherein the first data comprises a base 36 encoded version of the hashed data.

18. The method of claim 1, wherein the hash function is a cryptographic hash function.

19. The method of claim 18, wherein the hash function is SHA-256.

20. The method of claim 1, wherein an authoritative name server for the first domain name is different from an authoritative name server for the second domain name.

21. The method of claim 1, wherein an authoritative name server for the first domain name is the same as an authoritative name server for the second domain name.

22. The method of claim 1, wherein the response to the domain name system query or the zone file describing the second domain name comprises verification permissions.

23. Apparatus arranged to perform the method of claim 1.

24. (canceled)

25. A computer-readable medium comprising a computer program, arranged, when executed, to perform the method of claim 1.

26. A method for use in performing verification associated with a first domain name using a hierarchical domain name system, the method comprising:
creating and/or storing a resource record describing a second, different domain name, wherein the second domain name comprises the first domain name, wherein the second domain name comprises at least one label preceding the first domain name, wherein the at least one label preceding the first domain name comprises first data, wherein the first data comprises or is based on hashed data, the hashed data having been derived based on input data having been mapped to the hashed data using a hash function, and wherein the input data comprises at least one verifiable identifier.

27. A method for use in performing verification associated with a first domain name using a hierarchical domain name system, the method comprising:
receiving a domain name system query comprising a second, different domain name, wherein the second domain name comprises the first domain name, wherein the second domain name comprises at least one label preceding the first domain name, wherein the at least one label preceding the first domain name comprises first data, wherein the first data comprises or is based on hashed data, the hashed data having been derived based on input data having been mapped to the hashed data using a hash function, and wherein the input data comprises at least one verifiable identifier; and
transmitting a response to the domain name system query.
